(19) United States
(12) Patent Application Publication
(10) Pub. No.: US 2005/0088007 A1
(43) Pub. Date: Apr. 28, 2005

(54) Covering sheet supporting structure

(76) Inventor: Real Royer, Ville-Marie (CA)

Correspondence Address: Real Royer;c/o Louis Tessier, 60 ave. Balfour, Mont-Royal, QC, H3P 1L6, CA

(21) Appl. No.: 10/690,273

(22) Filed: Oct. 22, 2003

(51) Int. Cl. B60P 7/02

(52) U.S. Cl. 296/100.17

(57) ABSTRACT

A supporting structure for supporting a tarpaulin over a container opening defined by a container body. The supporting structure includes generally elongated supporting bows pivotally attached to the container body so as to allow the bows to pivot between a bow operational configuration wherein the bow spans substantially transversally across the container opening and a stored configuration wherein the supporting bows are at least partially retracted from the container opening and extend in a substantially proximal relationship relative to the container first side wall. The supporting bows are also pivotally attached to the container body so as to allow the bows to pivot about a bow first end between a bow higher position wherein an opposed bow second end is raised and a bow lowered position wherein the bow second end is located substantially underneath the bow raised position. A bow biasing mechanism biases the supporting bows towards the bow raised position.

### FIELD OF THE INVENTION

The present invention relates to the general field of open-top containers and is particularly concerned with a supporting structure for supporting a covering sheet over an open top container.

### BACKGROUND OF THE INVENTION

Vehicle cargo containers for transporting bulk material such as sawdust, gravel chip, cutter shavings and the like typically include open top boxes such as semi-trailers or the like defining side walls, a front wall, a rear wall and a floor. These open top containers are typically mechanically coupled to various types of vehicles such as cargo ships, railway carts and truck cabins for transporting goods between various locations.

During transportation in these so-called open top containers, there exists a substantial risk that a portion of the load may be blown out of the open top container by various physical phenomena such as vibration, aerodynamically created vacuum, wind or the like. If some of the load is accidentally blown out of the container it may potentially not only cause unnecessary wastage of the transported goods but may also create a dangerous situation.

For example, when the open-top container is attached to a truck cabin, some of the load accidentally blown out of the container may contaminate the road or highway as it whirls around thus causing dangerous ground road conditions. It may also be blown directly towards the windshield of following vehicles creating a potentially disastrous situation.

Accordingly, in many areas, regulations have been implemented for the carriage of various loads, particularly on public highways requiring that open top containers be provided with some type of covering structure for covering the loading aperture during transport. With the increasing number of accidents, these official requirements have become more and more stringent, sometimes requiring adequate coverage for the load on even short journeys.

Consequently, there has been an industry wide move to provide permanently installed flexible covers often referred to as tarpaulins or tarps that can be quickly rolled and unrolled by the driver so as to respectively allow selective uncovering and covering of the load. When these permanently installed tarpaulins are used only occasionally they may be stored on the vehicle in a folded condition and unfolded over the body as and when required.

Various configurations of tarpaulins have been proposed. However, two configurations have proven to be particularly popular. One such configuration is the so called end-rolled tarpaulin which is gathered at one of the longitudinal ends of the container when not in use and moved along the body of the container between operative and stored positions.

The end-rolled tarpaulins are typically gathered at the front end of the vehicle and are usually provided along their length with a number of transverse supporting bars which extend between the two longer side walls of the container. The end-rolled tarpaulins are typically moved by means of a pair of cables trained over pulleys and carrying the tarpaulins with them as they move. With such an arrangement, the movement of the tarpaulin typically moves the bows automatically out of the way so that the latter do not obstruct the re-loading through the top opening. The movement of the bows out of the way also reduces the risks of having the latter damaged by a new load.

The other type of permanently installed tarpaulins preferred by some haulers is commonly referred to as a side-load tarpaulin. The side-load tarpaulins typically, permanently extend the full length of the container body and are rolled and unrolled about the roll rod that also typically extends the full length of the container body. The tarpaulin is supported, for a better positioning, by a given number of bows normally fitted in a transverse manner over the container, fixed by proper ropes and hooked to the container side walls.

Conventional bows typically include a downwardly turned end which is sized and oriented to engage a recess formed in a top rail of each side of the container. These recesses are normally simply downwardly extending apertures in the top rail. The recesses are configured and sized such that the corresponding ends of the bows are substantially fittingly insertable within the recesses with little play permitted. This provides for a substantially tight fit of the bow ends in the recesses which is necessary so that the bows are not subjected to excess movement or vibration when the container is moving.

The bows support the tarpaulin over the load contained in the trailer. They prevent the tarpaulin from being damaged by contact with the material within the container and also cause the tarpaulin to have an arched profile which readily sheds rainwater and helps to keep the material dry. They also facilitate movement of the roll-bar and assist placement of the covering material over the opening. Furthermore, they sometimes also act as structural reinforcements for the container side walls.

Although useful, conventional bows suffer from numerous drawbacks. A first major drawback is that they typically hinder access to the interior of the container. Another particularly troublesome problem that has arisen from the use of the arched support bows is that they are frequently damaged when the material is being loaded into the container. The damage can occur in instances such as if, for example, a front end loader bucket should contact the bows or if contacted portions of the material impact the bows as the material is being loaded into the container. Even regular exposure to relatively small items such as granular material may cause excessive abrasion of the bows by prolonged contact over time.

The damaged bows must then be repaired or replaced, usually at frequent intervals or at significant costs. If the vehicle operator should fail to notice that a bow has been broken or if the bow should be broken while the container is away from a repair facility, the tarpaulin can be easily punctured by the broken bow. In addition to the damage which can be caused to the bows and the tarpaulin, the material loading process may cause the vehicle's sideboards to be broken if the bows are impacted with a sufficient force.

Because of the risk of damage to the support bows and sideboards during the loading of material into the vehicle, conventional bows often need to be removed, or at least one end of each bow must be removed so that the bows can then be pivoted out of the way. Typically, the vehicle operator will sometimes climb into the container trailer and remove the bows prior to loading and then replace the bows before the tarpaulin is placed over the loaded material.

Removal and replacement of the bows causes significant delays in the loading process and is also objectionable from a safety standpoint as it subjects the operator to a risk of slipping and falling while climbing into or out of the trailer or container. This manual moving of tarpaulin bows is a tedious and sometimes dangerous maneuver. An operator can easily fall into the load material or off the side of the truck or container resulting in injury to the operator and/or to the load material. This is particularly true when the load in the container is slippery or when the truck and its load are icy.

Furthermore, because of the tight fit, the bows are often difficult to remove from the corresponding recesses when desired. This difficulty in removing the bows from the recesses is further aggravated whenever the bows become dented or misshaped in any way. Accordingly, it is often necessary to strike the underside of the bows with a large hammer or the like in order to remove the end of the bow from the associated recess. By striking the bow with sufficient force to dislodge it, the problem of bending or the like damaging the bow is accentuated.

Also, when the bows are removed, they are typically positioned on the ground nearby the container. Consequently, the bows can be lost or stolen with obvious difficulties in the preparation of the container for the shipment.

In attempts to circumvent the above-mentioned disadvantages associated with conventional bows, some prior art documents have proposed bows that are pivotally attached at one end thereof to one side of the container opening and configured at the other end to reversibly engage the other side of the container opening.

For example, U.S. Pat. No. 4,915,439 naming Nello Cranaro as inventor, issued Apr. 10, 1990, discloses a tarpaulin support structure wherein the supporting bows may be moved to an inoperative stored position alongside the container wall by means of a handle at the lower end of a pivot rod and accessible to an operator standing on the ground. The opposite side wall typically carries a ramp member that is engaged by the free end of the bows during the final movement into the operative position in which they extend fully across the container body.

The ramp members are provided in case the free end of the bows sags too far downward.

U.S. Pat. No. 5,487,584 naming Lee Jespersen as inventor, issued Jan. 30, 1996 discloses a series of bows pivotally connected together by a ridge-pole. The ridge-pole insures that all the bows move in unison or are uniformally prohibited from movement.

Although the hereinabove-mentioned patents provide a partial solution to some of the hereinabove-mentioned drawbacks associated with conventional static bows, they nevertheless still present major disadvantages. For example, the structures disclosed in the hereinabove-mentioned patents fail to provide a means for lifting, at least partially, the bows away from the container opening and/or the load contained therein during pivotal movement of the bows between the operative and stored configurations. Hence, the bows risk frictionally contacting the structure of the container and/or the load during pivotal movement which, in turn, may lead to jamming of the bows in an intermediate position.

U.S. Pat. No. 6,261,100 naming Leon Koester as inventor, and issued Mar. 26, 2002 discloses an apparatus for removing bows from their position over a truck bed. The apparatus includes a control bar positioned along the upper edge of one side of the container with a multiplicity of bows extending radially from the bar. A lever for rotating the control bar is also attached to the bar.

When the control bar is rotated outwards, the bows rotate upward and away from the open truck bed. Conversely, when the control bar is rotated inwards, the bows are lowered to extend across the truck bed to support the tarpaulin thereon. A major disadvantage associated with such a structure is that it requires an additional step, namely the rotation of the control bar, which may prove to be tedious and time-consuming.

### SUMMARY OF THE INVENTION

Accordingly, there exists the need for an improved support system for a covering. It is therefore a general object of the present invention to provide an improved support system for a covering.

In accordance with the present invention, there is provided a supporting structure for supporting a covering sheet over a container opening defined by a container body, the container body including a container first side wall and a container second side wall both extending from a container base wall in a transversally spaced apart relationship relative to each other, the container first and second side walls respectively defining a first and a second side wall upper peripheral edge, the supporting structure comprising: a generally elongated supporting bow defining a bow first end and a longitudinally opposed bow second end; a bow-to-first wall attachment means for attaching the bow first end to the first container first side wall, the bow-to-first wall attachment means allowing the supporting bow to extend in a bow operational configuration wherein the bow spans substantially transversally and at least partially across the container opening; the bow-to-first wall attachment means also allowing the bow to pivot about the bow first end between a bow higher position wherein the bow second end is its raised position and a bow lowered position wherein the bow second end is in its lowermost position located substantially underneath the bow raised position; a bow biasing means extending between the container body and the supporting bow for biasing the supporting bow towards the bow raised position.

Typically, the bow biasing means resiliently biases the bow second end towards the bow raised position. Conveniently, supporting bow is sized so as to extend transversally across the container opening, the bow-to-first wall attachment means allowing the bow second end to abuttingly contact the second side wall upper peripheral edge when the supporting bow is in the bow operational configuration lowered position.

Conveniently, the bow biasing means is calibrated so as to bias the bow second end generally upwardly and away from the second side wall upper peripheral edge when the supporting bow is in the operational configuration.

Typically, the supporting bow and the bow biasing means are calibrated so as to allow the bow second end to abuttingly contact the second side wall upper peripheral edge when the supporting bow is in the operational configuration and the covering sheet is at least partially deployed over the supporting bow with the weight of the covering sheet exerting a downwardly oriented force on the bow second end against the biasing force generated by the bow biasing means, the supporting bow and the bow biasing means being also calibrated so as to allow the bow second end to be spaced away from the second side wall upper peripheral edge by the bow biasing means when the supporting bow is in the operational configuration and the downwardly oriented force is reduced by having the covering sheet at least partially retracted from the supporting bow.

Optionally, the bow biasing means is provided with a biasing force adjustment means for allowing the customization of the biasing force exerted by the bow biasing means.

Typically, the bow-to-first wall attachment means includes an anchoring component attachable to the container first side wall substantially adjacent the first side wall upper peripheral edge; the bow biasing means including a spring component mechanically coupled to both the anchoring component and the supporting bows. Conveniently, the spring component includes a spring rod made out of a substantially resiliently deformable material.

Preferably, the supporting bow is pivotable between the operational configuration and a stored configuration wherein the supporting bow is at least partially retracted from the container opening. Typically, the supporting bow extends in a substantially proximal relationship relative to the container first side wall when in the stored configuration.

Conveniently, the supporting structure further includes an actuating means operatively coupled to the supporting bow for pivoting the supporting bow between the operational and stored configurations. Typically, the actuating means includes an actuating rod mechanically coupled to the bow first end, the actuating rod extending substantially adjacent the exterior surface of the container first side wall.

Typically, the supporting structure includes at least two supporting rods, each of the supporting rods defining a bow first end and a longitudinally spaced bow second end; a bow-to-first wall attachment means for attaching the each of the bow first ends to the first container side wall, the bow-to-first wall attachment means allowing the supporting bows to extend in a bow operational configuration wherein the bows span substantially transversally and at least partially across the container opening; the bow-to-first wall attachment means also allowing the bows to pivot about the bows first end between a bow higher position wherein the bows second ends are in their raised position and a bow lowered position wherein the bow second ends are in their lowermost position located substantially underneath the bow raised positions; a bow biasing means extending between the container body and the supporting bows for biasing the supporting bows towards the bow raised position; the supporting bow being pivotable between the operational configuration and a stored configuration wherein the supporting bows are at least partially retracted from the container opening; a bow connecting means for connecting the supporting bows together and allowing the supporting bows to pivot substantially in unison between the operational and stored configurations.

Conveniently, the bow connecting means includes a connecting pole pivotally coupled to the supporting bows intermediate the bow first and second ends; the supporting bows being in a substantially parallel relationship relative to each other and in a substantially perpendicular relationship relative to the connecting pole when the supporting bows are in the operational configuration.

Typically, the supporting structure includes a pivotal range limiting means for limiting the pivotal range of the supporting bows as the bows pivot between the operational and stored configurations.

Conveniently, the bow connecting means includes a connecting pole pivotally coupled to the supporting bows intermediate the bow first and second ends; the supporting bows being in a substantially parallel relationship relative to each other and in a substantially perpendicular relationship relative to the connecting pole when the supporting bows are in the operational configuration, the connecting pole defining a pair of connecting pole side peripheral edges, the pivotal range limiting means including abutment plates extending from the connecting pole side peripheral edges, the abutment plates being positioned, configured and sized for abuttingly contacting at least one of the supporting bow when the supporting bows reach the operational and stored configurations.

Typically, the pivotal range limiting means includes a pair of abutment plates extending from the connecting pole, the abutment plates being positioned so as to be on opposite sides of a given supporting bow and adjacent opposite connecting pole peripheral edges, each of the abutment plates defining an abutment plate longitudinal abutment edge and an abutment plate transversal abutment edge for contacting a portion of the given supporting bow respectively when the supporting bow is in the stored configuration and when the supporting bow is in the operational configuration.

Advantages of the present invention include that the proposed support structure can be used for supporting a covering component such as a tarpaulin over an opening such as an open-top container. The support structure is designed so as to be useable with different types of containers including truck bodies, railcar bodies, swap bodies or the like. The support structure is designed so as to be easily installable and/or retro-fittable on such open-top containers.

Also, the proposed support structure is designed so as to be easily and readily moved at least partially out of the opening when the covering is removed. The support structure is designed so that the bows thereof can be moved between operative and stored positions by an operator standing on the ground at the side of the container through a set of quick, easy and ergonomic steps.

Also, the proposed support structure is specifically designed so as to allow pivotal movement of its components between operative and stored positions which reduce the risks of having some of its components frictionally engage the structural components of the container and/or the load contained therein.

Furthermore, the proposed support structure is designed so as to be manufacturable using conventional forms of manufacturing in order to provide a support structure that will be economically feasible, long-lasting and relatively trouble-free in operation.

Other objects and advantages of the present invention will become apparent from a careful reading of the detailed description provided herein, within appropriate reference to the accompanying drawings.

### BRIEF DESCRIPTION OF THE DRAWINGS

An embodiment of the present invention will now be disclosed, by way of example, in reference to the following drawings in which:

FIG. 1, in a partial perspective view with sections taken out, illustrates a support structure in accordance with an embodiment of the present invention, the support structure being shown mounted on an open-top container and in an operational configuration;

FIG. 2, in a partial perspective view with sections taken out, illustrates a handle and a locking mechanism both part of the support structure shown in FIG. 1;

FIG. 3, in a partial top view with sections taken out, illustrates the support structure shown in FIG. 1 being pivoted towards its stored configuration;

FIG. 4, in a partial side elevational view, illustrates part of a support structure in accordance with an embodiment of the present invention mounted on an open-top container, the support structure being shown in a raised configuration;

FIG. 5, in a side elevational view with sections taken out, illustrates the support structure shown in FIG. 4 in a lowered configuration;

FIG. 6, in a partial top view with sections taken out, illustrates part of the support structure in accordance with an embodiment of the present invention, the support structure being shown in an operational configuration;

FIG. 7, in a transversal cross-sectional view taken along arrows 7-7 of FIG. 6, illustrates the relationship between a connecting rod and a bow component both part of the support structure shown in FIG. 6 when the latter is in an operational configuration;

FIG. 8, in a partial cross-sectional view taken along arrows 8-8 of FIG. 6, illustrates the relationship between a connecting rod and a bow component, both part of the supporting structure shown in FIG. 6 when the latter is in an operational configuration;

FIG. 9, in a partial perspective view with sections taken out, illustrates part of tarpaulin about to be attached to an anchoring component part of the supporting structure in accordance with an embodiment of the present invention;

FIG. 10, in a front elevational view, illustrates the anchoring component shown in FIG. 9;

FIG. 11, in a side elevational view, illustrates the anchoring component shown in FIGS. 9 and 10;

FIG. 12, in a partial cross-sectional view with sections taken out, illustrates the relationship between the anchoring component shown in FIGS. 9 through 11 and various other components part of the supporting structure in accordance with an embodiment of the present invention; and

FIG. 13, in a partial exploded view, illustrates an abutment component about to be inserted within a bow component, both the abutment and bow components being part of a supporting structure in accordance with an embodiment of the present invention.

### DETAILED DESCRIPTION OF THE PREFERRED EMBODIMENT(S)

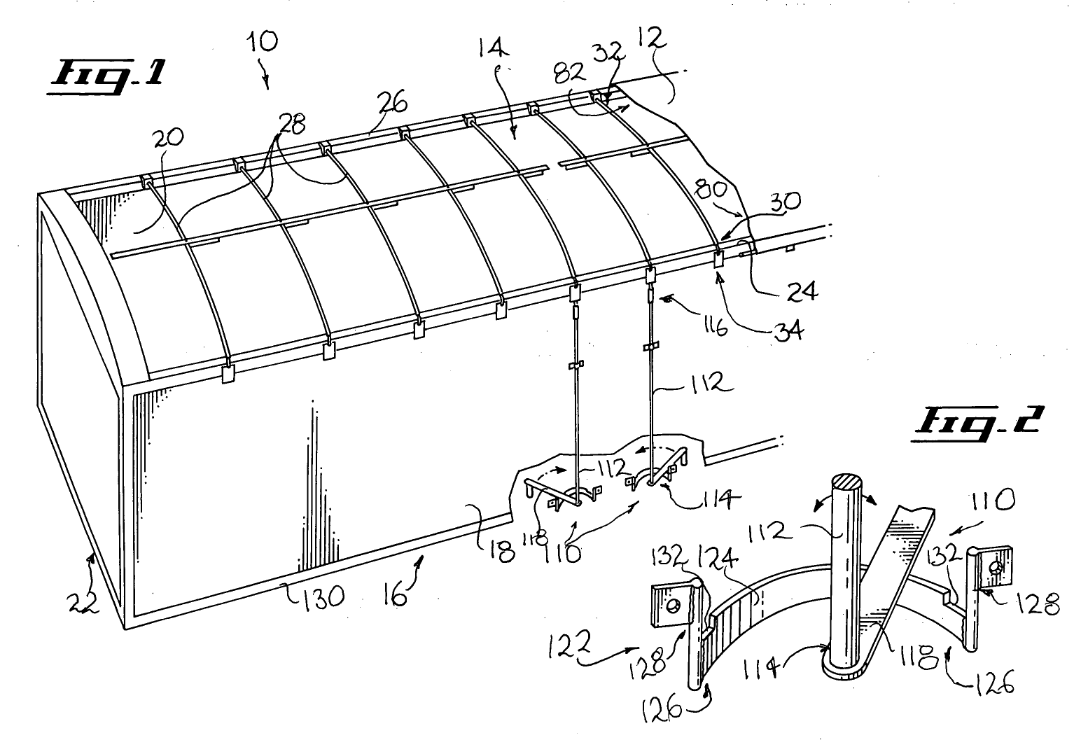

Referring to FIG. 1, there is shown a supporting structure 10 in accordance with an embodiment of the present invention. The supporting structure 10 is shown supporting a covering sheet 12 over the top opening 14 of a container body 16.

Typically, the covering sheet 12 is a conventional tarpaulin used for covering the top opening 14 of a truck trailer 16. It should, however, be understood that the supporting structure 10 could be used with other types of covering sheets 12 and container or bodies and in other contexts without departing from the scope of the present invention.

In FIG. 1, the container body 16 is shown including a container first side wall 18 and a container second side wall 20 both extending from a container base wall 22 in a substantially transversely spaced apart relationship relative to each other. The container first and second side walls 18, 20, respectively define a first and a second side wall upper peripheral edge 24, 26.

The supporting structure 10 includes at least one, and preferably a plurality of generally elongated supporting bows 28. Each supporting bow 28 defines a corresponding bow first end 30 and a longitudinally opposed bow second end 32.

The supporting structure 10 also includes a bow-to-first wall attachment means 34 for attaching each bow first end 30 to the container first side wall 18. The bow-to-first attachment means 34 allows the supporting bows 28 to extend in a bow operational configuration shown in FIGS. 1, 4 and 5 wherein the bows 28 span substantially transversely and at least partially across the container opening 14. It should be understood that although throughout the Figures the bows 28 are shown as extending across the container top opening 14, the bows 28 could extend only partially thereacross without departing from the scope of the present invention.

As illustrated more specifically in FIGS. 4 and 5, the bow-to-first wall attachment means 34 also allows the bows 28 to pivot according to arrow 36 substantially above the bow first end 30 between a bow raised or higher position as shown in FIG. 4 wherein the bow second end 32 is in its highermost or raised position and a bow lowered position as shown in FIG. 5 wherein the bow second end 32 is in its lowermost or lowered position located substantially underneath the bow raised position.

The supporting structure 10 further includes a bow biasing means 38 extending between the container body 16 and the supporting bows 28 for biasing the supporting bows 28 towards the bow raised position shown in FIG. 4. Typically, the bow biasing means 38 resiliently biases the bow second end 32 towards the bow raised position.

Typically, each supporting bow 28 is sized so as to extend transversely across the container opening and the bow-to-first wall attachment means 34 hence allowing the bow second end 32 to abuttingly contact the second side wall upper peripheral edge 26 when the supporting bows 28 are in their bow operational configuration and lowered position such as shown in FIGS. 1 and 5.

As illustrated more specifically in FIGS. 4, 5, and 13, an abutment component 40 is typically attached to each supporting bow 28 substantially adjacent to the bow second end 32. The abutment components 40 are configured and sized for abuttingly contacting the second side wall upper peripheral edge 26.

As shown more specifically in FIG. 13, each abutment component 40 typically has a substantially L-shaped configuration defining an abutment component first leg 42 extending in a direction substantially perpendicular to the supporting bow 28 and the abutment component second leg 44 extending in a direction substantially parallel to the supporting bow 28. The proximal ends of the abutment component first and second legs 42, 44 preferably merge integrally into each other and define a substantially rounded inner edge 46.

Also, preferably, the respective distal ends 48, 50 of the abutment component first and second legs 42, 44 preferably have a substantially rounded contour. The abutment components 40 may be releasably attached to the supporting bow 28 in order to facilitate replacement thereof when they become worn out or otherwise damaged. Also, releasable attachment of the components 40 may allow for customization of their configuration depending on the configuration of the second side wall upper peripheral edge 26.

For example, an attachment tongue 52 configured and sized for slidable insertion within a corresponding bow channel 54 may extend from the rear surface 56 of the abutment component first leg 42. It should be understood that other attachment means of the releasable or fixed type may be used for attaching the abutment component 40 to corresponding supporting bows 28 without departing from the scope of the present invention.

Typically, the bow biasing means 38 is calibrated so as to bias the bows second end 32 generally upwardly and away from the second side wall upper peripheral edge 26 when the supporting bows 28 are in their operational configuration. The strength of the biasing force generated by the bow biasing means 38 is typically calibrated so as to space the bow second end 32 away from the second side wall upper peripheral edge 26 when the covering sheet 12 is at least partially retracted from the supporting bows 28. In other words, the biasing force generated by the bow biasing means is typically calibrated so that once the covering sheet 12 reaches a predetermined degree of withdrawal from the supporting bows 28, the weight of the supporting sheet is no longer sufficient to maintain the bow second end 32 against the second side wall upper peripheral edge 26 allowing the bow biasing means 38 to lift the bow second end 32.

Conversely, the biasing force generated by the bow biasing means is typically calibrated to allow the bow second end 32 to abuttingly contact the second side wall upper peripheral edge 26 when the covering sheet 12 is at least partially overriding the supporting bows 28. In other words, the biasing force generated by the bow biasing means 38 is calibrated so that it may be neutralized by the weight of the covering sheet 12 when the latter reaches a predetermined degree of deployment over the supporting bows 28.

Optionally, the bow biasing means may be provided with a biasing force adjustment means for allowing the customization of the biasing force exerted by the bow biasing means. Hence, for example, the strength of the biasing force generated by the bow biasing means 38 may be customized depending on the type and weight of covering sheet 12 upon the deployment and retraction position of the covering sheet 12 relative to the supporting bows 28 wherein it is desirable that the supporting bows 28 initiate the pivotal movement according to arrow 36.

As illustrated more specifically in FIG. 12, the bow-to-first wall attachment means 34 typically includes an anchoring component 58 attachable to the container first side wall 18, preferably substantially adjacent the first side wall upper peripheral edge 26 and also preferably on an exterior surface of the container first side wall 18. Typically, the bow biasing means 38 includes a spring component extending between each anchoring component 34 and corresponding supporting bow 28.

Typically, each spring component includes a spring rod 60 made out of a substantially resiliently deformable material. Typically, the spring rod 60 is bent about the spring rod elbow 62 i8 nto a substantially L-shaped configuration defining a spring rod first leg 64 and a spring rod second leg 66. The spring rod first leg 64 is typically mechanically coupled to the anchoring component 58 while the spring rod second leg 66 is typically mechanically coupled to the supporting bow 28.

Typically, the spring rod 60 is configured and sized so that the spring rod first segment 64 extends in a substantially parallel relationship relative to the container first side wall 18 and so that the spring rod second segment 66 extends in a direction leading substantially over the container opening 14. The spring rod second segment 66 hence forms a second segment-to-opening angle 68 between the spring rod second segment 66 and the top surface of the container opening 14. Typically, although by no means exclusively, the second segment-to-opening angle 68 has a value substantially in the range of between 1 and 75 degrees when the bow second end 32 is in the raised or highermost configuration.

As illustrated in FIG. 12, each supporting bow 28 is typically provided with a supporting bow channel 70 extending substantially longitudinally thereinto about the bow first end 30. Also, the anchoring component 58 is typically provided with a spring rod receiving channel 32 extending at least partially thereinto.

The supporting bow proximal channel 70 is configured and sized for slidably receiving at least a portion of the spring rod second segment 66. An abutment flange 34 typically limits insertion of the spring rod second segment 66 within the supporting bow proximal channel 70.

Similarly, the spring rod receiving channel 72 is configured and sized for slidably receiving at least a portion of the spring rod first leg 64. Typically, a first and a second segment sleeves 76, 78 are positioned respectively between the spring rod receiving channel 72 and the spring rod first segment 64 and between the supporting bow proximal channel 70 in the spring rod second segment 66.

As illustrated in FIG. 1, the covering sheet 12 defines a covering sheet first transversal end 80 and a transversally opposed covering sheet second transversal end 82. The covering sheet first and second transversal ends 80, 82 are respectively attachable to the container body 16 respectively adjacent the container first and second side walls 18, 20 when the covering sheet 12 is deployed over the supporting bows 28. First and second covering sheet attachment means are typically provided for attaching the covering sheet first and second ends 30, 32.

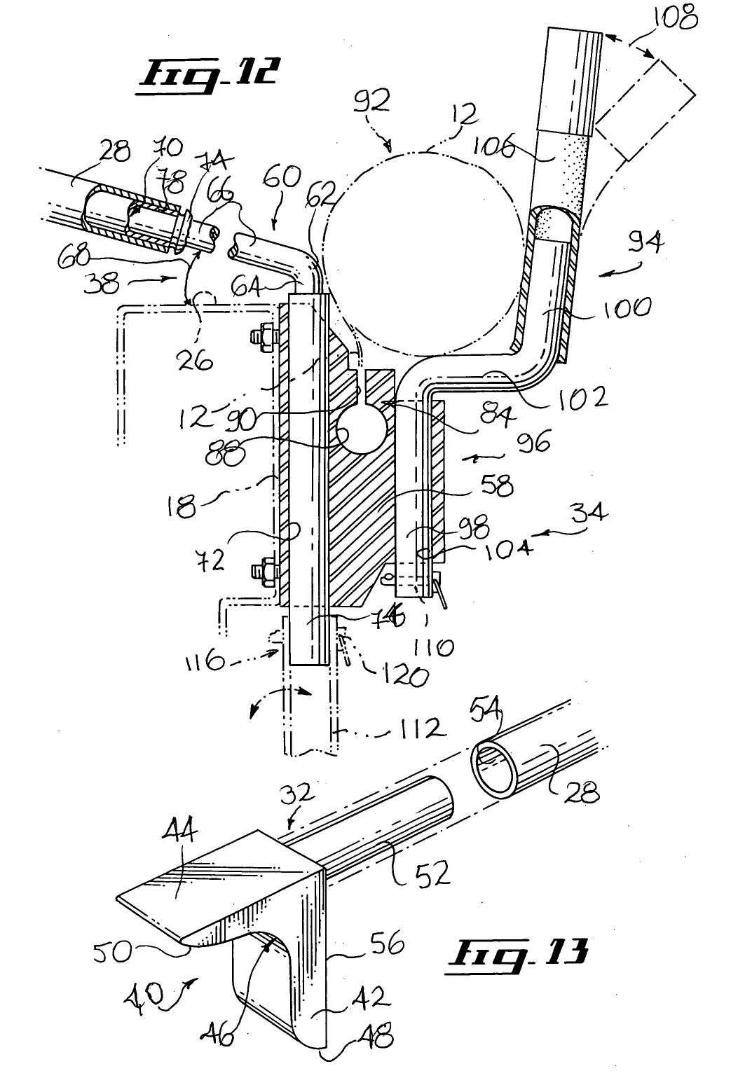

As illustrated in FIGS. 9 through 12, the anchoring block 58 is preferably provided with a covering sheet attachment means 84 for attaching the covering sheet first end 80 thereto. As shown in FIG. 9, the covering sheet first end 80 is typically wrapped or attached around a sheet pole 86.

The covering sheet attachment means 84 typically includes a covering sheet attachment channel extending at least partially through the anchoring component 58. The covering attachment channel typically extends in a substantially parallel relationship with the container first side wall 18 and in a substantially perpendicular relationship with the spring rod receiving channel 72.

Typically, the covering sheet attachment channel defines a covering sheet channel first section 88 configured and sized for slidably receiving the sheet pole 86. The covering sheet attachment channel also defines a second section 90 thereof leading into the first section 88. The second section is configured and sized for slidably receiving a segment of the covering sheet 12 when the sheet and pole assembly is slidably inserted according to arrow 92 within the covering sheet attachment channel as illustrated in FIG. 9.

As illustrated in FIG. 12, the covering sheet 12 is typically rollable into a sheet roll 92 when retracted from the supporting bows 28. Typically, the covering sheet 12 is rolled and unrolled about a roll rod (not shown) that extends substantially the full length of the container body 16 as is well known in the art. The anchoring block 58 further includes a roll receiving means 94 for receiving the sheet roll 92.

The roll receiving means 94 typically includes a roll abutment rod 96 extending from the anchoring block 58. The roll abutment rod 96 is configured and sized for cooperating with adjacent structures in receiving the sheet roll 92. Typically, the roll abutment rod 96 defines an abutment rod first segment 98, an abutment rod second segment 100 and an abutment rod third segment 102 extending therebetween. The abutment rod first and second segments 98, 100 extend in a substantially parallel relationship relative to each other and in a substantially perpendicular relationship relative to the abutment rod first segment 102.

The anchoring block 58 also defines an abutment rod receiving channel 104 extending at least partially therethrough for receiving at least a portion of the abutment rod first segment 98. Typically, the abutment rod second segment 100 is provided with a rod extension 106 extending generally upwardly therefrom. The rod extension 106 is preferably made out of a substantially resiliently deformable material in order to allow the rod extension 106 to bend according to arrow 108 when the latter contacts the contacting surface such as a roof or the like.

Also, optionally, the roll abutment rod 96 is provided with a releasable locking means for releasably locking the latter to the anchoring component 58. The releasable locking means may take any suitable form such as a locking pin 110 inserted in a corresponding pin aperture formed in the rod first segment 98.

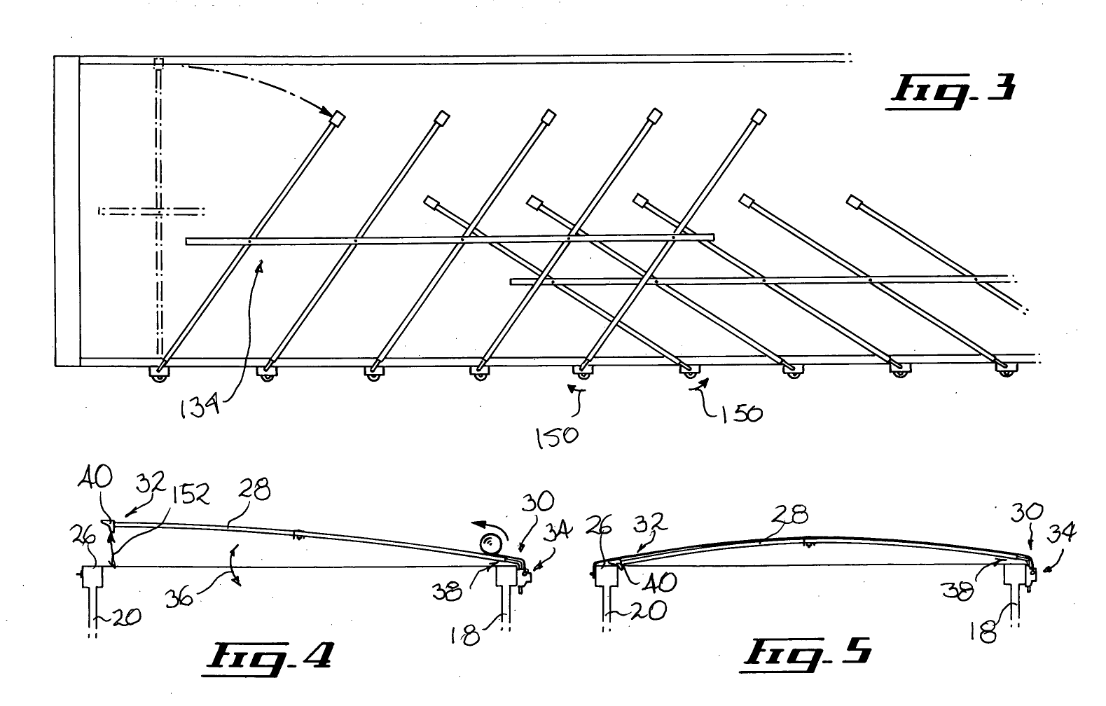

As illustrated in FIG. 3, at least one and preferably all of the supporting bows 28 are preferably pivotable between the operational configuration wherein they span transversely across the container opening 14 and a stored configuration (not shown) wherein the supporting bows 28 are at least partially retracted from the container opening 14. FIG. 3 illustrates the supporting bows 28 in an intermediate position between the operational and stored configurations. Typically, the supporting bows 28 extend in a substantially proximal and parallel relationship relative to the container first side wall 18 when in the stored configuration.

As illustrated in FIGS. 1 and 2, the supporting structure 10 is typically provided with an actuating means 110 operatively coupled to the supporting bows 28 for pivoting the latter between the operational and stored configurations. Typically, the actuating means xxx110 includes an actuating rod 112 mechanically coupled to the bow first end 30. The actuating rod 112 typically extends substantially adjacent with and in a parallel relationship to the exterior surface of the container first side wall 18.

Each actuating rod 112 defines a corresponding actuating rod first end 114 and a longitudinally opposed actuating rod second end 116. The actuating rod first end 114 is typically provided with a handle 118 for facilitating the movement of the supporting bows 28 between the operational and stored configurations. As shown in FIG. 12, the actuating rod second end 116 is typically releasably coupled to the sleeve 76 using a suitable releasable attachment means such as attachment pin 120.

Typically, the handle 118 is positioned so as to extend inwardly underneath the container base wall 22. Typically, the supporting structure 10 is further provided with a bow locking means 122 for locking the supporting bows 28 in either one of the operational or stored configurations. The bow locking means typically includes a locking component mounted on the container body 16 substantially adjacent the container base wall 22. The locking component is configured and sized for operatively cooperating with the handle 118 for locking the supporting bows 28 in either one of the operational or stored configuration.

Typically, the locking component includes a generally arcuate locking plate 124 defining an arc segment between a pair of opposed locking plate ends 126. Locking plate attachment prongs 128 typically extend from locking plate 124 adjacent the locking plate ends 126 for allowing the locking plate 124 to be attached to the inner surface of the base wall flange 130.

The locking plate 124 has a locking notch 132 formed therein substantially adjacent the locking plate ends 126. The handle 118 is positioned, configured and sized for releasable locking insertion into a corresponding one of the locking notches 132 when the supporting bows 28 are in a corresponding one of the operational or stored configurations.

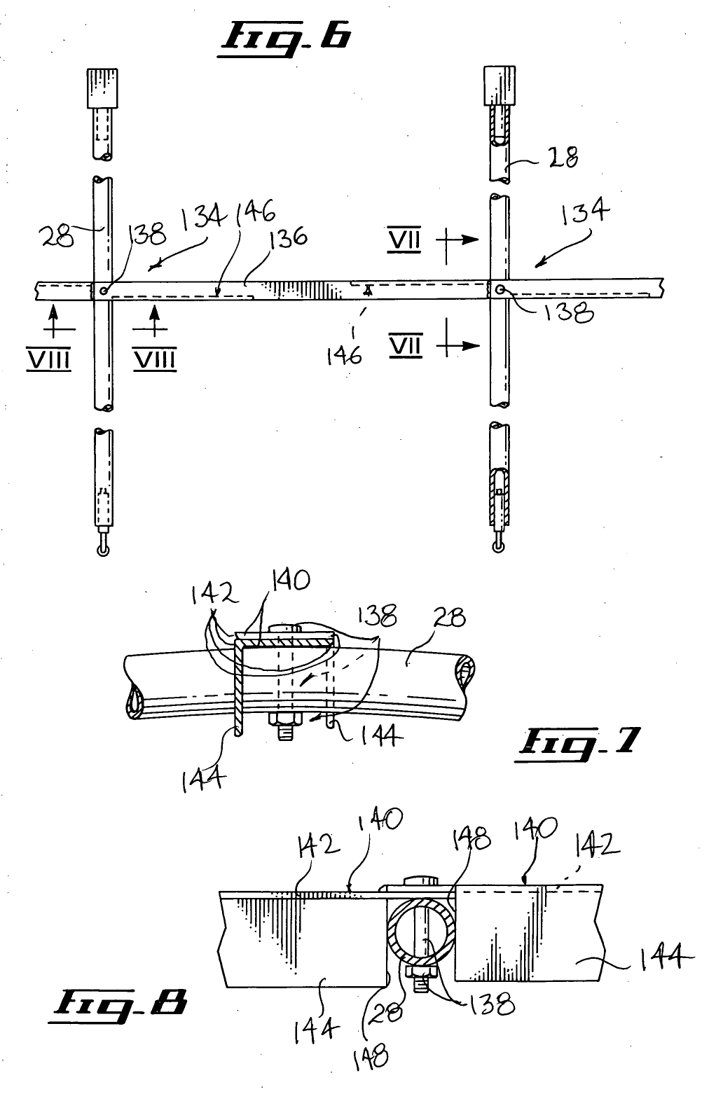

As illustrated more specifically in FIGS. 3 and 6 through 8, the supporting structure 10 is typically further provided with a bow connecting means 134 for correcting the supporting bows 28 together to pivot substantially in unison between the operational and stored configurations. Typically, the bow connecting means includes a connecting pole 136 pivotally coupled to the supporting bows 28 intermediate the bow first and second ends 30, 32.

The connecting pole 136 and the supporting bows 28 may be pivotally coupled together using any suitable connecting pole-to-supporting bow pivotal coupling means such as a bolt and nut combination 138. The connecting pole 136 and the supporting bows 28 are preferably pivotally attached together. Typically, the supporting bows 28 are in a substantially parallel relationship relative to each other and in a substantially perpendicular relationship relative to the connecting pole 136 when the supporting bows 28 are in the operational configuration such as shown in FIGS. 1 and 6 through 8.

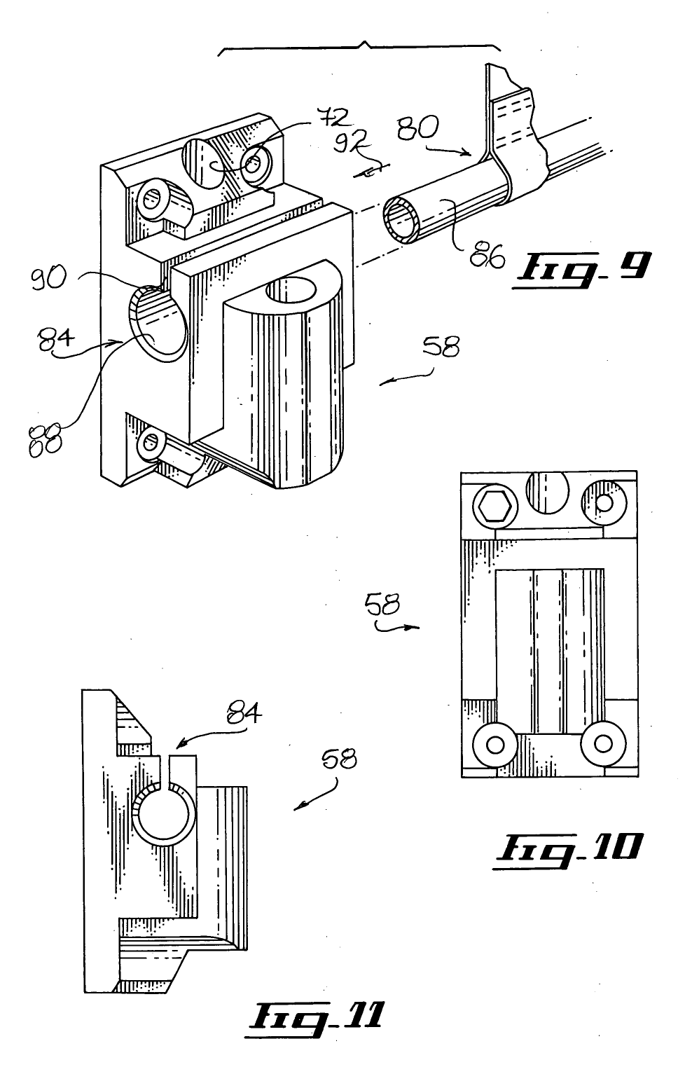

The supporting structure 10 typically further includes a pivotal range limiting means for limiting the pivotal range of the supporting bows 28 as they pivot between the operational and stored configurations. As shown more specifically in FIGS. 7 and 8, the connecting pole 136 is typically formed of pole segments attached together and each defining a substantially flat pole top segment 140. The pole top segments 140 in turn, define a pair of opposed connecting pole side peripheral edges 142.

The pivotal range limiting means typically includes abutment plates 144 extending from the connecting pole side peripheral edges 142. As shown in FIG. 7, the abutment plates 144 may extend integrally from the pole top segment 140. The abutment plate 144 are positioned, configured and sized for abuttingly contacting the outer surface of a corresponding supporting bow 28 when the supporting bows 28 reach the operational and stored configurations.

Typically, the abutment plates 144 are positioned so as to be on opposite sides of a given supporting bow 28 and adjacent opposite connecting pole peripheral edges 142. Each abutment plate 144 defines an abutment plate longitudinal abutment edge 146 and an abutment plate transversal abutment edge 148. The abutment plate longitudinal and transversal abutment edges are adapted to contact a portion of the given supporting bow 28 respectively when the supporting bow 28 is in the stored configuration and when the supporting bow 28 is in the operational configuration.

As illustrated in FIG. 3, the supporting bows 28 are preferably grouped in units of supporting bows 28 pivoting independently from other units of supporting bows 28. Typically, the supporting structure is configured so that at least two units of supporting bows 28 pivot according to arrows 150 in opposite directions relative to each other between the operational and stored configurations.

In use, the bow biasing means is intended to lift the supporting bows 28 away from the container opening 14 and the load contained therein during pivotal movement of the supporting bows 28 between the operational and stored configurations. The spacing 152 creating by the bow biasing means 38 between the container opening 14 and the bow second longitudinal end 32 reduces the risks of having the supporting bows 28 contact or frictionally engage parts of the container body 16 or the material stored therein.

The bow biasing means is typically calibrated so as to lift the supporting bows 28 towards the raised or highermost position automatically upon at least partial withdrawal of the cover sheet 12 from the supporting bows 28 without requiring any intervention from an intended operator. Also, the bow biasing means 38 is calibrated so as to allow for pivotal movement of the supporting bows 28 towards the lowered configuration shown in FIG. 5 upon at least partial deployment of the covering sheet 12 over the supporting bows 28, again without requiring intervention on behalf of an intended operator.

1. A supporting structure for supporting a covering sheet over a container opening defined by a container body, said container body including a container first side wall and a container second side wall both extending from a container base wall in a transversally spaced apart relationship relative to each other, said container first and second side walls respectively defining a first and a second side wall upper peripheral edge, said supporting structure comprising:
a generally elongated supporting bow defining a bow first end and a longitudinally opposed bow second end;
a bow-to-first wall attachment means for attaching said bow first end to said first container first side wall, said bow-to-first wall attachment means allowing said supporting bow to extend in a bow operational configuration wherein said bow spans substantially transversally and at least partially across said container opening; said bow-to-first wall attachment means also allowing said bow to pivot about said bow first end between a bow higher position wherein said bow second end is its raised position and a bow lowered position wherein said bow second end is in its lowermost position located substantially underneath said bow raised position;
a bow biasing means extending between said container body and said supporting bow for biasing said supporting bow towards said bow raised position.

2. A supporting structure as recited in claim 1 wherein said bow biasing means resiliently biases said bow second end towards said bow raised position.

3. A supporting structure as recited in claim 1 wherein said supporting bow is sized so as to extend transversally across said container opening, said bow-to-first wall attachment means allowing said bow second end to abuttingly contact said second side wall upper peripheral edge when said supporting bow is in said bow operational configuration lowered position.

4. A supporting structure as recited in claim 3 further comprising an abutment component attached to said supporting bow substantially adjacent said bow second end for abutingly contacting said second side wall upper peripheral edge.

5. A supporting structure as recited in claim 4 wherein said abutment component has a substantially “L”-shaped configuration defining an abutment component first leg extending in a direction substantially perpendicular to said abutment component first leg and an abutment component second leg extending in a direction substantially parallel to said supporting bow.

6. A supporting structure as recited in claim 3 wherein said bow biasing means is calibrated so as to bias said bow second end generally upwardly and away from said second side wall upper peripheral edge when said supporting bow is in said operational configuration.

7. A supporting structure as recited in claim 6 wherein said supporting bow and said bow biasing means are calibrated so as to allow said bow second end to abuttingly contact said second side wall upper peripheral edge when said supporting bow is in said operational configuration and said covering sheet is at least partially deployed over said supporting bow with the weight of said covering sheet exerting a downwardly oriented force on said bow second end against the biasing force generated by said bow biasing means, said supporting bow and said bow biasing means being also calibrated so as to allow said bow second end to be spaced away from said second side wall upper peripheral edge by said bow biasing means when said supporting bow is in said operational configuration and said downwardly oriented force is reduced by having said covering sheet at least partially retracted from said supporting bow.

8. A supporting structure as recited in claim 6 wherein said
covering sheet has a sheet weight under the action of gravity;
said bow biasing means being calibrated so as to space said bow second end away from said second side wall upper peripheral edge when said covering sheet is substantially retracted from said supporting bow;
said bow biasing means being calibrated so as to allow said bow second end to abuttingly contact said second side wall upper peripheral edge when said covering sheet is at least partially overriding said supporting bow with said sheet weight at least neutralizing the biasing force exerted by said bow biasing means.

9. A supporting structure as recited in claim 8 wherein said supporting bow has a substantially exteriorly convex configuration.

10. A supporting structure as recited in claim 1 wherein said bow biasing means is provided with a biasing force adjustment means for allowing the customization of the biasing force exerted by said bow biasing means.

11. A supporting structure as recited in claim 1 wherein
said bow-to-first wall attachment means includes an anchoring component attachable to said container first side wall substantially adjacent said first side wall upper peripheral edge;
said bow biasing means including a spring component mechanically coupled to both said anchoring component and said supporting bow.

12. A supporting structure as recited in claim 11 wherein said spring component includes a spring rod made out of a substantially resiliently deformable material.

13. A supporting structure as recited in claim 12 wherein said spring rod is bent about a spring rod elbow into a substantially “L”-shaped configuration defining a spring rod first leg and a spring rod second leg, said spring rod first leg being mechanically coupled to said anchoring component and said spring rod second leg being mechanically coupled to said supporting bow.

14. A supporting structure as recited in claim 13 wherein said spring rod is configured and sized so that said spring rod first segment extends in a substantially parallel relationship relative to said container first side wall and said spring rod second segment extends in a direction leading substantially over said container opening, said spring rod second segment forming a second segment-to-opening angle between said spring rod second segment and said container opening, said second segment-to-opening angle having a value in the range of between 1 and 75 degrees when said bow second end is in said highermost configuration.

15. A supporting structure as recited in claim 13 wherein
said supporting bow is provided with a supporting bow channel extending longitudinally thereinto from said bow first end;
said anchoring component is provided with a spring rod receiving channel extending at least partially thereinto;
said supporting bow channel being configured and sized for slidably receiving at least a portion of said spring rod second segment and said spring rod receiving channel being configured and sized for slidably receiving at least a portion of said spring rod first segment.

16. A supporting structure as recited in claim 15
wherein said covering sheet defines a covering sheet first end and a covering sheet second end attachable adjacent to said container body respectively adjacent said container first and second side walls when said covering sheet is deployed over said supporting bow;
said anchoring block further including a covering sheet attachment means for attaching said covering sheet first end.

17. A supporting structure as recited in claim 16 wherein said covering sheet attachment means includes a covering sheet attachment channel extending at least partially through said anchoring component, said covering sheet attachment channel extending in a substantially parallel relationship with said container first side wall and in a substantially perpendicular relationship with said spring rod receiving channel.

18. A supporting structure as recited in claim 15 wherein
said covering sheet is rollable into a sheet roll when retracted from said supporting bow;
said anchoring block further including a roll receiving means for receiving said sheet roll.

19. A supporting structure as recited in claim 18 wherein said roll receiving means includes a roll abutment rod extending from said anchoring block, said roll abutment rod being configured and sized for cooperating in receiving said sheet roll.

20. A supporting structure as recited in claim 19 wherein said roll abutment rod defines an abutment rod first segment, an abutment rod second segment and an abutment rod third segment extending therebetween, said abutment rod first and second segments extending in a substantially parallel relationship relative to each other and in a substantially perpendicular relationship relative to said abutment rod third segment, said anchoring block also defining an abutment rod receiving channel extending at least partially therethrough for receiving at least a portion of said abutment rod first segment.

21. A supporting structure as recited in claim 20 wherein said abutment rod second segment is provided with a rod extension extending therefrom, said rod extension being made out of a resiliently deformable material.

22. A supporting structure as recited in claim 1 wherein said supporting bow is pivotable between said operational configuration and a stored configuration wherein said supporting bow is at least partially retracted from said container opening.

23. A supporting structure as recited in claim 22 wherein said supporting bow extends in a substantially proximal relationship relative to said container first side wall when in said stored configuration.

24. A supporting structure as recited in claim 23 further comprising an actuating means operatively coupled to said supporting bow for pivoting said supporting bow between said operational and stored configurations.

25. A supporting structure as recited in claim 24 wherein said actuating means includes an actuating rod mechanically coupled to said bow first end, said actuating rod extending substantially adjacent the exterior surface of said container first side wall.

26. A supporting structure as recited in claim 25 wherein said actuating rod defines an actuating rod first end and a longitudinally opposed actuating rod second end, said actuating rod first end being provided with a handle for facilitating the movement of said supporting bow between said operational and stored configurations.

27. A supporting structure as recited in claim 22 further comprising a bow locking means for locking said supporting bow in either one of said operational or stored configuration.

28. A supporting structure as recited in claim 22 comprising an actuating means operatively coupled to said supporting bow for pivoting said supporting bow between said operational and stored configurations, said actuating means including an actuating rod mechanically coupled to said bow first end, said actuating rod extending substantially adjacent the exterior surface of said container first side wall; said actuating rod defining an actuating rod first end and a longitudinally opposed actuating rod second end, said actuating rod first end being provided with a handle for facilitating the movement of said supporting bow between said operational and stored configurations; said supporting structure further comprising a bow locking means for locking said supporting bow in either one of said operational or stored configuration, said bow locking means including a locking component mounted on said container body substantially adjacent said container base wall, said locking component being configured and sized for operatively cooperating with said handle for locking said supporting bow in either one of said operational or stored configurations.

29. A supporting structure as recited in claim 28 wherein said locking component includes a generally arcuate locking plate defining an arc segment between a pair of opposed locking plate ends, said locking plate having a locking notch formed therein substantially adjacent said locking plate ends, said handle being positioned, configured and sized for releasable locking insertion into a corresponding one of said locking notches when said supporting bow is in a corresponding one of said operational or stored configurations.

30. A supporting structure as recited in claim 1 including at least two supporting rods,
each of said supporting rods defining a bow first end and a longitudinally spaced bow second end;
a bow-to-first wall attachment means for attaching said each of said bow first ends to said first container side wall, said bow-to-first wall attachment means allowing said supporting bows to extend in a bow operational configuration wherein said bows span substantially transversally and at least partially across said container opening; said bow-to-first wall attachment means also allowing said bows to pivot about said bows first end between a bow higher position wherein said bows second ends are in their raised position and a bow lowered position wherein said bow second ends are in their lowermost position located substantially underneath said bow raised positions;
a bow biasing means extending between said container body and said supporting bows for biasing said supporting bows towards said bow raised position;
said supporting bow being pivotable between said operational configuration and a stored configuration wherein said supporting bows are at least partially retracted from said container opening;
a bow connecting means for connecting said supporting bows together and allowing said supporting bows to pivot substantially in unison between said operational and stored configurations.

31. A supporting structure as recited in claim 30 wherein said bow connecting means includes a connecting pole pivotally coupled to said supporting bows intermediate said bow first and second ends; said supporting bows being in a substantially parallel relationship relative to each other and in a substantially perpendicular relationship relative to said connecting pole when said supporting bows are in said operational configuration.

32. A supporting structure as recited in claim 30 further comprising a pivotal range limiting means for limiting the pivotal range of said supporting bows as said bows pivot between said operational and stored configurations.

33. A supporting structure as recited in claim 32 wherein said bow connecting means includes a connecting pole pivotally coupled to said supporting bows intermediate said bow first and second ends; said supporting bows being in a substantially parallel relationship relative to each other and in a substantially perpendicular relationship relative to said connecting pole when said supporting bows are in said operational configuration, said connecting pole defining a pair of connecting pole side peripheral edges, said pivotal range limiting means including abutment plates extending from said connecting pole side peripheral edges, said abutment plates being positioned, configured and sized for abuttingly contacting at least one of said supporting bow when said supporting bows reach said operational and stored configurations.

34. A supporting structure as recited in claim 33 wherein said pivotal range limiting means includes a pair of abutment plates extending from said connecting pole, said abutment plates being positioned so as to be on opposite sides of a given supporting bow and adjacent opposite connecting pole peripheral edges, each of said abutment plates defining an abutment plate longitudinal abutment edge and an abutment plate transversal abutment edge for contacting a portion of said given supporting bow respectively when said supporting bow is in said stored configuration and when said supporting bow is in said operational configuration.

35. A supporting structure as recited in claim 22 including at least two pairs of supporting bows, each of said pairs being pivotable in opposite directions relative to each other between said operational and stored configurations.
